(19) United States
(12) Patent Application Publication
(10) Pub. No.: US 2002/0106099 A1
(43) Pub. Date: Aug. 8, 2002

(54) Covering device for an earphone

(76) Inventor: Hsi Kuang Ma, Taipei (TW)

Correspondence Address: Dougherty & Troxell, ONE SKYLINE PLACE, SUITE 1404, 5205 LEESBURG PIKE, FALLS CHURCH, VA, 22041, US

(21) Appl. No.: 09/788,380

(22) Filed: Feb. 21, 2001

(30) Foreign Application Priority Data
Feb. 5, 2001 (TW) 90201751

(51) Int. Cl. H04R 25/00

(52) U.S. Cl. 381/371; 381/370; 381/380

(57) ABSTRACT

A covering device for an earphone, especially for a plug earphone comprises two coverings and a covering connection. The respective covering provides a lateral face to face each other and a fitting groove is arranged to extend inward from the respective lateral face for accommodating the plug earphone. Both ends of the covering connection connect with the two coverings so that the covering device can be worn while in use.

### BACKGROUND OF THE INVENTION

1. Field of the Invention

The present invention relates to a covering device for an earphone, and particularly to an covering device for a plug earphone.

2. Description of Related Art

The earphone has been utilized for years and provides a function of transmitting sound to our ears. Hence, it is much helpful for formation communication, receiving broadcast, and listening to the stereo by way of the earphone.

Generally, the earphone nowadays can be classified into two categories, and one is the earphone with coverings as shown in FIG. 1. Basically, the earphone with coverings provides two coverings and an arc frame to connect with these two coverings. The earphone with coverings can be comfortably worn to cover the ears. But, it is not so convenient to be carried about, especially during going out because of its big size.

The other category of earphone is the plug earphone as shown in FIG. 2. Although the plug earphone has an advantage of being carried about easily due to smaller size, it still has its disadvantages. For instance, sometimes it is difficult to be located in the ears and the user may feel uncomfortable due to the plug earphone being kept in the ears in case of using.

Thus, both types of earphones are prepared for some persons such as WALKMAN users such that the earphone with coverings is used at home and the plug earphone is used during out. In this way, it can be understood that more expense is needed and making a proper arrangement is required. As a result, these become a burden to the user.

### SUMMARY OF THE INVENTION

An object of the present invention is to provide a covering device for an earphone, which is possible for a user to use the plug earphone with a function of having coverings without the need of preparing an additional earphone with coverings.

### BRIEF DESCRIPTION OF THE DRAWINGS

The present invention can be more fully understood by referring to the following description and accompanying drawings, in which:

FIG. 1 is a plan view of conventional covering type of earphone;

FIG. 2 is a plan view of conventional plug type of earphone; and

FIG. 3 is a plan view of coverings on an earphone according to the present invention.

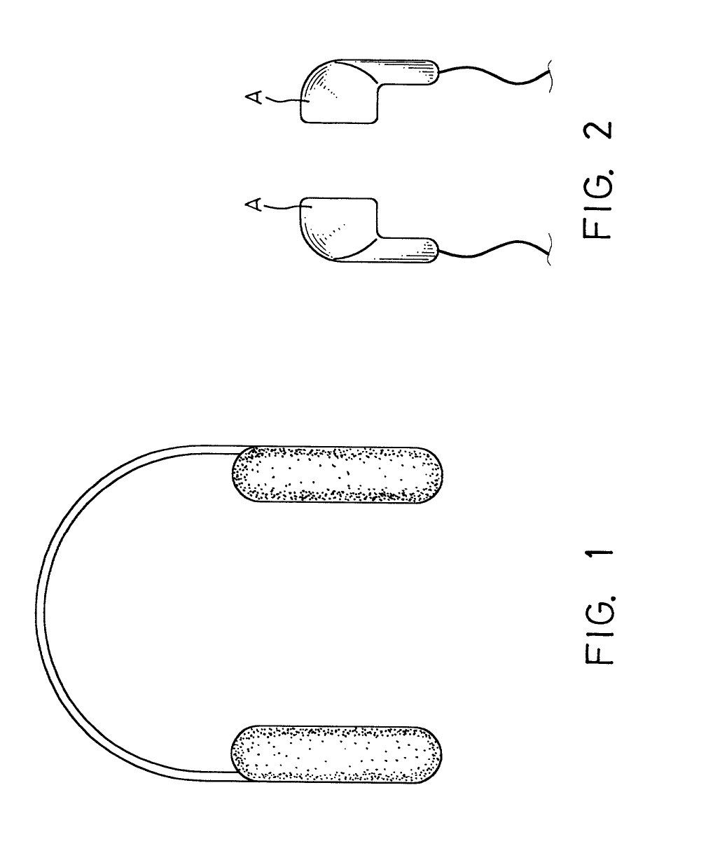

### DETAILED DESCRIPTION OF THE PREFERRED EMBODIMENTS

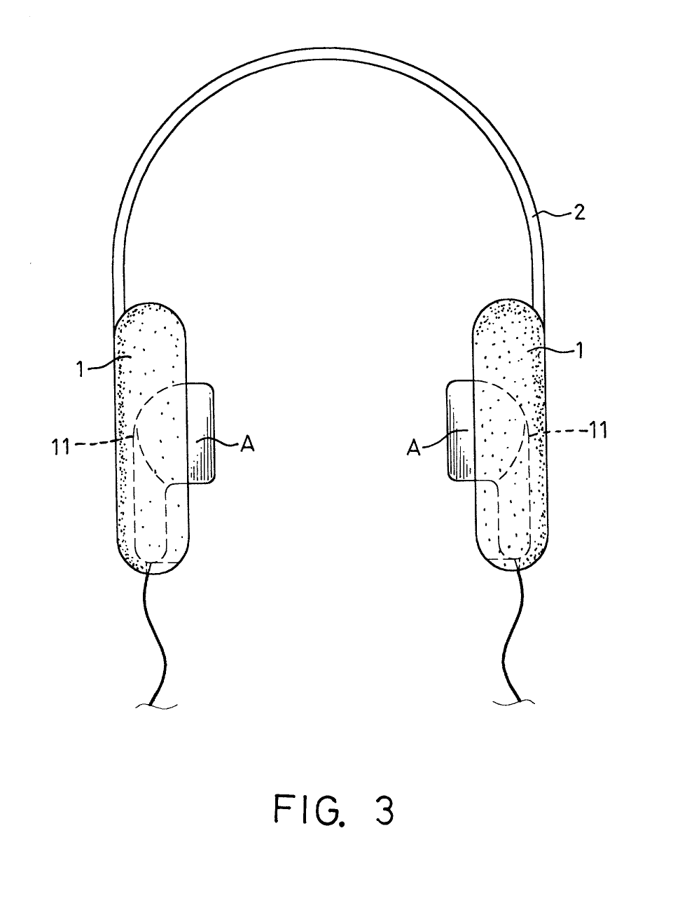

Referring to FIG. 3, coverings on a earphone of present invention basically comprises two coverings 1, and a covering connection 2.

Each one of coverings 1 is solid and provides a specific thickness. In order to be worn comfortably, a lateral face of covering confronting the corresponding ear at the time of the earphone being worn is provided with a soft pad. Because the arrangement of soft pad is prior art, no detail will be described further.

The characteristic of present invention resides in that the lateral face confronting the corresponding ear, i.e., the inner lateral face provides a fitting groove 11 with a size corresponding to the plug earphone “A”. Thus, the plug earphone “A” can be received therein and the fitting groove 11 has a deepness to locate the plug earphone “A” at the least. Hence, the plug earphone “A” can be flush with the lateral end face or extend a little bit outward from the lateral end face.

The covering connection 2 at both ends thereof joins the coverings 1 with an adjustable position or a fixed position. Because these are prior art, no detail will be described further.

Referring to FIG. 3 again, while the coverings of the present invention is in use, the plug earphone plug is received in the fitting groove 11 and the sound signal can output from the plug earphone “A”. While the user is out and the coverings of present invention is not in use, the plug earphone “A” can be taken out from the coverings of present invention for being used independently.

Accordingly, as soon as the coverings for an earphone according to the present invention is used, the plug earphone can perform the function of earphone with coverings. In addition, it is possible for the user to have choices in different situations. These advantages of the present invention are not possible to be attained if the conventional plug earphone or the conventional earphone with coverings is used.

While the invention has been described with reference to preferred embodiment thereof, it is to be understood that modifications or variations may be easily made without departing from the spirit of this invention, which is defined by the appended claims.

What is claimed is:

1. A covering device for an earphone, especially for a plug earphone, comprising
two coverings, each of said two coverings providing a lateral face being oppositely disposed to each other, a fitting groove being arranged to extend inward from the lateral face to accommodate the plug earphone; and
a covering connection with two ends, connecting with said two coverings at said two ends so as to be worn while in use.

2. The set of coverings for earphone according to claim 1, wherein the lateral face on the respective coverings may be added a soft pad.
